(19) United States
(12) Patent Application Publication
(10) Pub. No.: US 2012/0254108 A1
(43) Pub. Date: Oct. 4, 2012

(54) Synchronization Of Data For A Robotic Device

(75) Inventors: Brett Wedewer, Kirkland, WA (US); Lei Zhao, Issaquah, WA (US); Gilbert Wong, Bellevue, WA (US); Nate Clinton, Sammamish, WA (US); Emil Gustafsson, Redmond, WA (US)

(73) Assignee: Microsoft Corporation, Redmond, WA (US)

(21) Appl. No.: 13/075,183

(22) Filed: Mar. 30, 2011

(51) Int. Cl. G06F 7/00

(52) U.S. Cl. 707/618; 707/610; 707/634; 707/E17.005

(57) ABSTRACT

Technology is described for synchronization of data between a robotic device and a cloud storage service. The method can include identifying data from a robotic device to be synchronized to the cloud storage service. A synchronization request and the data can then be sent to a robotic synchronization service on the robotic device, and the data can be stored on the robotic device's storage system. A further operation can be sending the data to cloud synchronization service. The data can be stored on the cloud storage service.

### BACKGROUND

Robotic devices can provide services for humans. Examples of a useful robot can be a simple autonomous robot to provide services to an elderly person or to patrol a workplace at night. Robotic devices can also have applications that control the operations that are performed by the robot. For example, one application may include functions for accomplishing navigation tasks by localizing or estimating the current location of the robotic agent and for navigating reliably to reach locations in the environment. Other example applications can include telecommunication, photo capture, video playback, audio playback, navigation locations, and video conferencing abilities.

Data can also be stored on robotic devices for the applications. For example, the configuration of applications, user's data such as captured photos, audio recordings, and/or additional user information can be stored on the robot. However, if a robotic device or the robotic device's subsystems malfunction, then the applications and data that are located on the robotic device may be come lost or corrupted.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. While certain disadvantages of prior technologies are noted above, the claimed subject matter is not to be limited to implementations that solve any or all of the noted disadvantages of the prior technologies.

Various examples are described for synchronization of data between a robotic device and a cloud storage service. The method can include identifying data from a robotic device to be synchronized to the cloud storage service. A synchronization request and the data can be sent to a robotic synchronization service on the robotic device, and the data can be stored on the robotic device's storage system. A further operation can be sending the data to cloud synchronization service. The data can be stored on the cloud storage service.

An example of a system for synchronization of data for a robotic device can be provided. The system can include a cloud storage service configured to store data. A cloud synchronization interface can receive data to be stored in the cloud storage service. A robotic device can store and process robotic configuration and application data. The robotic device can synchronize the configuration and application data with the cloud storage service using the cloud synchronization interface. A web portal to capture data for the robotic device and synchronize the data with the robotic device and cloud storage service via the cloud synchronization interface.

An example of a method for synchronization of data from a web portal to a cloud storage service and robotic device can be provided. This method can include identifying data captured by the web portal to be synchronized to the cloud storage service. The data can be sent to the cloud storage service using a cloud synchronization service. Another operation can be storing the data on the cloud storage service using the cloud synchronization service. In addition, the data can be sent to the robotic device using the cloud synchronization service. Further, the data can be stored on the robotic device's storage system.

### BRIEF DESCRIPTION OF THE DRAWINGS

FIG. 1 is a block diagram illustrating an example of a system for synchronization of data for a robotic device.

FIG. 2 is an example of a flowchart illustrating a method for synchronization of data between a robotic device and a cloud storage service.

FIG. 3 is a diagram illustrating an example of a synchronization process from a robotic device to cloud storage service.

FIG. 4 is a flowchart illustrating an example of a method for synchronization of data from a web portal to a cloud storage service and robotic device.

FIG. 5 is flowchart diagram illustrating an example of a method for synchronization of a web portal with a robotic device.

### DETAILED DESCRIPTION

Reference will now be made to the exemplary examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

Various types of data can be stored on an automated robotic device for the robotic device's applications, configuration of the applications and the user's data such as captured photos, recordings and/or additional user information. Data can be created and edited on a robotic device and through a web portal that can send information to the robotic device.

Users of a robotic device also would like the maintenance and upkeep of the robot to be as easy and seamless as possible. Keeping the robotic device and the web portal for interfacing with the robotic device synchronized so that both the robotic device and the web portal see the very latest data created at either location is useful. The robotic device and the web portal can also be synchronized with a cloud synchronization service and cloud storage. More specifically, this technology can synchronize data for a robotic device with data stored in the cloud storage service and data accessed on a web portal. Synchronizing the robotic device, the web portal, and the cloud storage can allow the restoration of lost or corrupted data for the applications, remote configurations, user data, and other data for the robotic device.

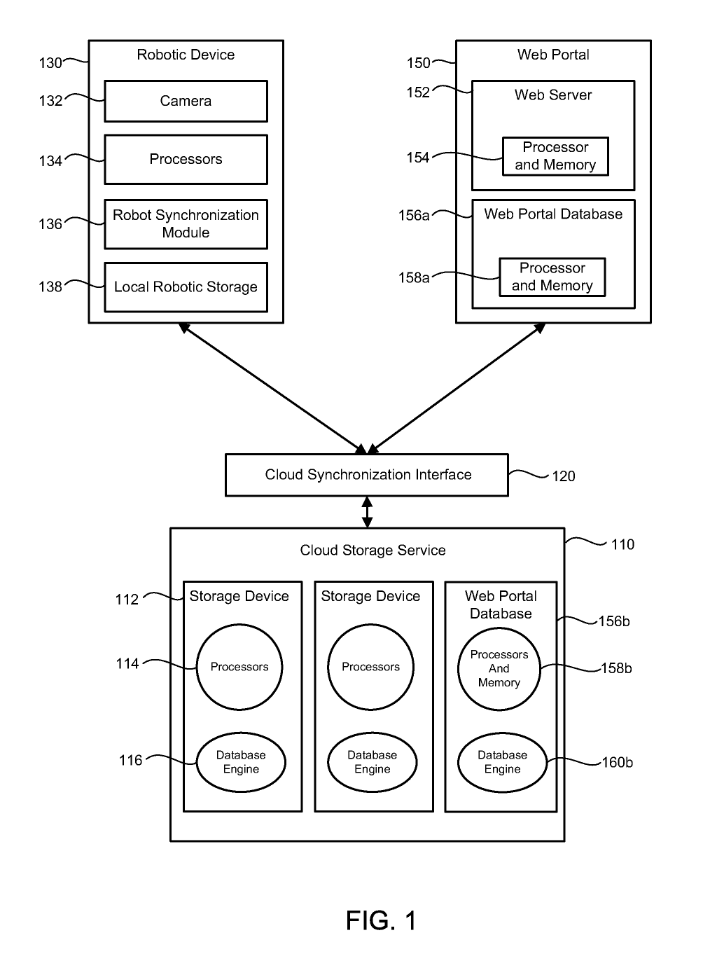

FIG. 1 illustrates a system for synchronization of data for a robotic device 130. The system can include a cloud storage service 110 configured to store data. The cloud storage service can contain many storage devices 112 and the storage devices can each contain processors 114 and a database engine 116. Each storage device may have one or more hardware storage devices that may include optical disk storage disks, RAM, ROM, EEPROM, flash memory, phase change memory, magnetic cassettes, magnetic tapes, magnetic disk storage or other magnetic storage devices, or any other computer storage medium which can be used to store the desired information.

A cloud synchronization interface 120 can also be included to receive data to be stored in the cloud storage service. The cloud synchronization interface can include network communication hardware and network connection logic to receive the information from a network. The network may be a local network (LAN), wide area network (WAN) or the internet. In addition, the cloud synchronization interface may include a queuing mechanism to organize the received requests for fulfillment by the cloud storage service 110. The cloud synchronization interface can be in communication with the cloud storage service to send requests to the cloud storage service for storing of data and to retrieve information for data requests.

A robotic device 130 can store and process robotic configuration data, application data, and user data. The robotic device can backup application states, application configurations, application data and user data. The robotic device can also backup the described data to the cloud storage service and this backup process and system will be described in further detail later. The robotic device may be an autonomous robot that can freely navigate through an environment using wheels and/or legs, or the robot may be a robotic arm or robotic device that is fixed as to position. In addition, the robotic device may include a camera 132 and processors 134 for performing robotic functions. Local robotic storage 138 can contain applications, application data, and user data that are obtained and used by the robotic device for application and web portal functions. The robotic device can synchronize the configuration and application data with the cloud storage service and a web portal using the cloud synchronization interface.

Examples of applications on robotic devices can include a navigation application for mobile robotic devices, a food delivery application, or a surveillance application to check on immobile persons. Another application can be an audio or video conferencing application where a person at a remote location can communicate with and have the robotic device follow a second person while producing video or audio conferencing. A music application can play music for a user and follow the user from location to location. An educational application may use a robotic device to teach a user how to perform a specific physical activity or exercise.

A web portal 150 can capture data for the robotic device and synchronize the data with the robotic device and cloud storage service 110 via the cloud synchronization interface 120. A web portal database 156a can be in communication with the web portal for storing configuration and application data in the web portal for the robotic device. In one example configuration, the web portal database may be stored locally on the web portal server or web portal computer hardware. The web portal database can include a processor and memory 158a in order to undertake the desired database communication and processing.

The web portal may also include a web server 152, and the web server can have a processor and memory 154 to provide the web pages, web applications and other web functions. The web portal database can be synchronized with the cloud storage service and robotic device. For example, the web portal can be used to setup robot configuration data, select applications to be loaded, upload files, and to configure other robot settings which create data for the robotic device. The data can be stored at the web portal and then the data can be sent over a network (e.g., the Internet) to the robotic device. More specifically, the configuration data can be synchronized to the robot from the web portal or website.

In another example configuration, the web portal database 156b can be stored in the cloud storage service 110. This allows the web portal data that is being presented to the user to be stored in the cloud. In addition, configuration data, application state data, user data or other data for the robotic device that is submitted to the web portal data can also be stored in the cloud storage service. The web portal database in the cloud storage service can have cloud allocated processors and memory 158b and a cloud allocated database engine 160b.

The robotic device 130 can contain a robot synchronization module 136 to backup robotic device configuration and other data from a robotic device's local storage system 138. The robot synchronization module can operate to keep the data from the robotic device in synchronization with the cloud storage service. This synchronization can further enable the backing up of: state data from the robotic device, robotic device application states, personal user data, and other data on the robotic device. The robotic device can also be set to backup just user data that is not a high security type of data or the robotic device may backup any user data that exists in the robotic device.

The synchronization for backups from the robot to the cloud storage service may take place on a configurable periodic basis, such as an hour or a day. This can be considered a scheduled synchronization because the synchronization is scheduled to take place on a synchronized basis. By default, the setting may be synchronization once per day. The scheduled synchronization can also check for updates that can be sent from the cloud to the robotic device. If there are any updates that need to be sent back to robot, the cloud-to-robot data will then be retrieved and synchronized.

Another type of synchronization can be a forced synchronization where a user changes data on the robotic device, and then an application with the changed data on the robotic device can trigger the application data to be synchronized to the cloud storage service. In other words, this synchronization type can be thought of as a “synchronize as soon as possible” operation. Synchronization can be triggered, but the robotic device or network may be in a high utilization mode currently and the synchronization may occur after the utilization drops below a configurable threshold. If there currently no utilization or the utilization drops below the threshold, the synchronization can execute.

Another type of synchronization can be a triggered synchronization where data from a web portal may change. An example of this synchronization is where an application is added to a robotic device. The end user can request that application data then be synced to the robotic device from the cloud. In other words, any time data changes occur on the web portal, a trigger can be fired to tell the web portal and cloud synchronization service to perform a forced synchronization for the robotic device. In the case that the web portal cannot contact the robotic device, the changes may not be received immediately and then the triggered synchronization can re-launch itself to try again within a configurable time period. The triggered synchronization can also result in a forced synchronization and can therefore operate in the same way with regard to a utilization threshold.

A further type of synchronization can be a lazy synchronization where a robotic device or cloud detects a change in the difference (delta) of stored data and only the changed data or difference data may be synchronized to the cloud. This type of synchronization can also be called change triggered syncing for a file change or part of a data set change.

Delta detection or detection of changes in the data can be used for managing state, state change detection, and/or conflict resolution in a transactional way for the robotic device. The ability to perform independent synchronization transactions can also provide the ability to add and/or remove any of changes to a robotic device in a “single transaction” which can aid in preventing orphan configuration settings.

When any one of the cases described above cause a synchronization action to occur, a synchronization manager in any of the agents (robotic device, web portal, or cloud storage) can control the actual synchronization. However, the location of the data to be synchronized may determine which synchronization manager controls the synchronization process.

For example, a synchronization manager can maintain a list of files since a synchronization was last done. The synchronization manager can compare the last synchronized version of each file in a data storage location with a version stored in the cloud storage service. This comparison may be performed file by file. If there is a difference between two versions of a file in the different locations, then the file can be synchronized. Once every file is successfully synchronized to the cloud, the synchronization service can clear the internal synchronized file list. If the synchronization is not successful for the files, the synchronization service can maintain a list of files which failed to synchronize to the cloud. This stored list can allow the synchronization manager to synchronize these files in the next scheduled synchronization.

A more detailed description of conflict resolution can be described where conflict resolution can take place between files that are desired to be synchronized. Initially, a file conflict is detected during synchronization. If a robotic device is trying to upload a file and the upload results in a conflict, then robot can download the file instead. In another situation, if the web portal tries to update a file and the update results in a conflict, the user can be notified and state of application can be based on a new version retrieved from the cloud synchronization service, optionally adding some known changes to the state. In another example, a message can be displayed where the user can be asked whether to proceed or abort with the synchronization of the file(s).

Note that conflicts are most likely to occur because two clients (e.g. a robotic device and web portal) concurrently updated the same file. Only the application using that file knows how to resolve such conflicts. If an application has some data where this simple conflict resolution is not enough, then the specific application can keep multiple versions of the file or one for each client and merge the changes separately (e.g., under an end user's supervision).

A restoration module can be located in the robot synchronization module 136 to restore data from the cloud storage service to the robotic device when the robotic device detects a data failure. For example, if some hardware of a robotic device fails, then a replacement robotic device may be obtained. In order to set the replacement robotic device to the same state as the failed robotic device, data can be restored using the cloud storage services 110 onto the replacement robot 130. This allows the replacement robotic device to start out with last state synchronized for the defective robotic device using the synchronization service to restore the data. The user work that was put into configuring the original defective robotic device can be transferred to another robotic device or used in restoring a state of an existing robotic device. If a user purchases an upgraded hardware version of a robotic device, then the same synchronization processes can be used to copy information from a previous version of the robotic device hardware to the upgraded version of the robotic device hardware. In another example, the cloud synchronization services can automatically restore data to a robotic device which detects data corruption or system failure. This restoration of data or previous state can include the ability to automatically synchronize applications, executables, data content, and/or configuration data (preferences and policy).

The data synchronized between the robotic device, web portal, and the cloud storage service can be synchronized using at least one identifier. For example, data may be tagged with an identifier that is a robot identifier, a user identifier, and an application identifier. In situations when the restoration module is activated to restore data, the data for restoration can be identified using the robot identifier, the user identifier, and/or the application identifier. For example, a robotic device can have more than one user backed up to the cloud synchronization service and each user may have identified data tied to the user. This can provide the ability to restore data for an individual user on a robotic device without restoring data for other users on the robotic device. When a user wants to restore just one application, then the data tied to one application ID (identifier) for synchronization can allow just one application to be restored to a robotic device. In addition, a user can apply a single user's data (e.g., configuration data) to multiple robots owned by the person or multiple persons. Organizing data by the robot ID, the user ID and the application ID can enable synchronization and recovery of data at a more granular level.

Using the described IDs also provides data that can be queried for and synchronized in any combination of robot id, user id and/or application id. This allows database queries and results to pivot on any of these identification values. For example, a query can be created that states “get a block of data for a specific robot ID, a specific user ID and application ID” or “get a block of data for a specific user ID and application ID across any existing robots”, etc.

A synchronization mechanism for robotic devices that uses a cloud storage service can be useful because backups may take place without the owners of the robotic device knowing anything about the backup. The backups can also allow a user to restore robotic devices after a catastrophic system failure or after a system upgrade using the web portal.

A further capability provided by this technology is that the synchronization can allow certain files to be accessed from multiple locations. File can be accessed that are located on the robotic device and then the same files can be accessed on the web portal or through the cloud storage system.

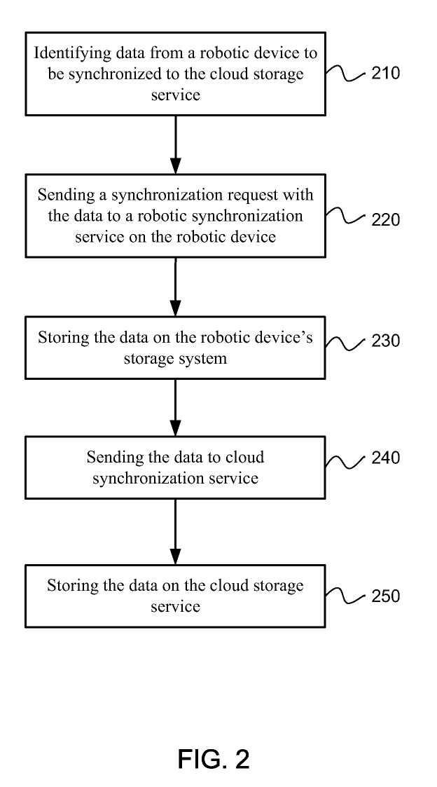

FIG. 2 illustrates a method for synchronization of data between a robotic device and a cloud storage service. The method can include the operation of identifying data from a robotic device to be synchronized to the cloud storage service, as in block 210. The data to be synchronized may include application data, configuration data, user data and other data stored by a robotic device.

A synchronization request can be sent with the data to a robotic synchronization service on the robotic device, as in block 220. Alternatively, the synchronization request can be sent and the data can be sent independently. As a result of this synchronization request, the data can also be stored on the robotic device's storage system, as in block 230. The synchronization of the data between the robotic device and the cloud synchronization service can take place using a variety of methods. In one method, data can be synchronized between the robotic device and the cloud synchronization service on a scheduled basis. So, data may be synchronized every hour, every 12 hours, every 24 hours, once a week or once a month depending on the synchronization schedule that has been setup by an end user of the robotic device or the synchronization default pre-set in the robotic device.

The data can also be sent to the cloud synchronization service, as in block 240. Then the data can then be stored on the cloud storage service, as in block 250. The data synchronized between the robotic device and the cloud storage service can be synchronized using at least one identifier such as a robot identifier, a user identifier, and an application identifier. The identifier can be used in storing the data into a database and subsequently retrieving the data from the database.

The following is a list of example cloud-based API (application program interface) functions that may be used in synchronization requests. This example list of APIs (application programming interfaces) can exist for the robot-side synchronization manager to call:

| Operation | Method | URI pattern(s) | Comment |
|---|---|---|---|
| File upload | PUT | /sync/{RID}/{APP}/{USR}/{FILE} | Returns 200 for |
| | | | updates, 201 for new |
| | | | files and 409 for |
| | | | conflicts. |
| File Download | GET | /sync/{RID}/{APP}/{USR}/{FILE} | Returns 200 for |
| | | | success or 404 if not |
| | | | found. |
| File delete | PUT | /sync/{RID}/{APP}/{USR}/{FILE} | Content length |
| | | | checked for zero. |
| | | | Returns 200 on |
| | | | success (or not found) |
| | | | or 409 for conflicts. |
| File query | GET | /sync/{RID} | Returns 200 and list |
| | | /sync/{RID}/{APP} | of all files for robot |
| | | /sync/{RID}/{APP}/{USR} | and their versions |
| | | | and checksum or 404. |
| | | | Note that there is no |
| | | | query for all files for |
| | | | a user regardless of |
| | | | application. |
| Service information | GET | /sync/about | Returns 200 and |
| | | | contains build |
| | | | number for service. |

Another synchronization example can include synchronizing data between the robotic device and the cloud synchronization service in a forced mode. Data can be synchronized when network bandwidth use or robotic device utilization drops below a defined utilization threshold. Thus, synchronization can be forced when the available network bandwidth or robotic device processor time is available. In particular, the forced synchronization can occur after a flag has been set that synchronization is needed. Alternatively, the robotic device can check to see if synchronization is needed when the available network and processing bandwidth becomes available. For example, synchronization of data can occur between a web portal, the cloud synchronization service, and the robotic device after a change to data has been captured by the web portal.

Each robotic device may store the robotic device's files in a separate container in the cloud based storage. This organization enables scanning for files for a robotic device without even checking table storage or indexing information. For example, the name of the container may be “sync_<robotid>”. This organization can also enable access control or management rights for each robot container stored in the cloud storage service. In addition, data of the blob data type in the container for the robotic device can have a name formed of a lower case GUID and the application id, user id and/or file name encoded. Meta data such as content type is typically not included in the blob in order to reduce a number of transactions used when uploading a file of the blob data type.

Data between the cloud synchronization service and the robotic device can also be synchronized using a lazy synchronization that synchronizes a changed data portion after a change occurs. This means that just new changes in data on the robotic device can be synchronized to the cloud synchronization service. In one example, a delta image can be created with the changes for a period of time (e.g., an hour) and then the delta changes can be synchronized at one time. Alternately, multiple deltas can be created at any interval and then be sent for synchronization.

Sometimes conflicts may arise in the synchronization of files between the robot and the cloud synchronization service. Time stamping files can help enable conflict resolution when synchronizing files for applications on the robotic device. Furthermore, a file for an application that is being synchronized may receive a conflict notice from cloud synchronization service and then the application can resolve the conflict.

In an additional example of conflict resolution, more than one place that a file can be modified may exist. Thus, the synchronization method may make sure that each agent (e.g., robot, web portal or cloud) is changing the same file. The ability to resolve a conflict may be based on storing a version number in the cloud. Alternatively, a random signature can be stored that tracks the latest file version. When the application updates the file, then the application can be specific about the version of the file desired to be updated. If the file version that is desired to be updated matches, then the file changes can be committed (e.g., the update completes) or if the file version does not match then the file changes can be rejected. In some situations where a file conflict exists, the device trying to synchronize can download the newest version of the file, resolve the conflict and update to the latest version of a file. An alternative method of conflict resolution can prevent overwriting changes for files with conflicts. When multiple agents (e.g., robot, web portal and cloud) try to update a file, the first agent can succeed and the other agents are configured to try again to synchronize later.

The cloud storage service can also be used for restoring data from the cloud storage service to the robotic device when the robotic device detects a data failure, data corruption, or the robotic device is reset. In one case, instructions can be sent to the cloud synchronization interface from a web portal to rebuild data or applications on the robotic device using files from the cloud synchronization service and/or web portal.

In an additional example of the technology, operations can be included to synchronize information from a web portal. An initial operation can be obtaining data relevant to the robotic device from a web interface. The data relevant to the robotic device can be application configuration data, an application to be installed, or user data. Examples of user data may be photos, sounds, videos, or other user data desired to be synchronized from the web interface to the robot in such a way the data is also synchronized to a cloud storage service. In another example, configuration data can be sent from a web portal to the robotic device via the cloud synchronization interface.

Once the relevant data has been identified, the data can be sent from the web interface to the cloud synchronization service. The data received by the cloud can be stored on the cloud storage service. The robotic device can be notified that a synchronization of data received from a web interface is going to occur. The synchronization notification to the robot can be followed by the data being sent from the cloud synchronization service to the robotic device. When the data is received from the cloud synchronization service, then the data can be stored on the robotic device's storage system.

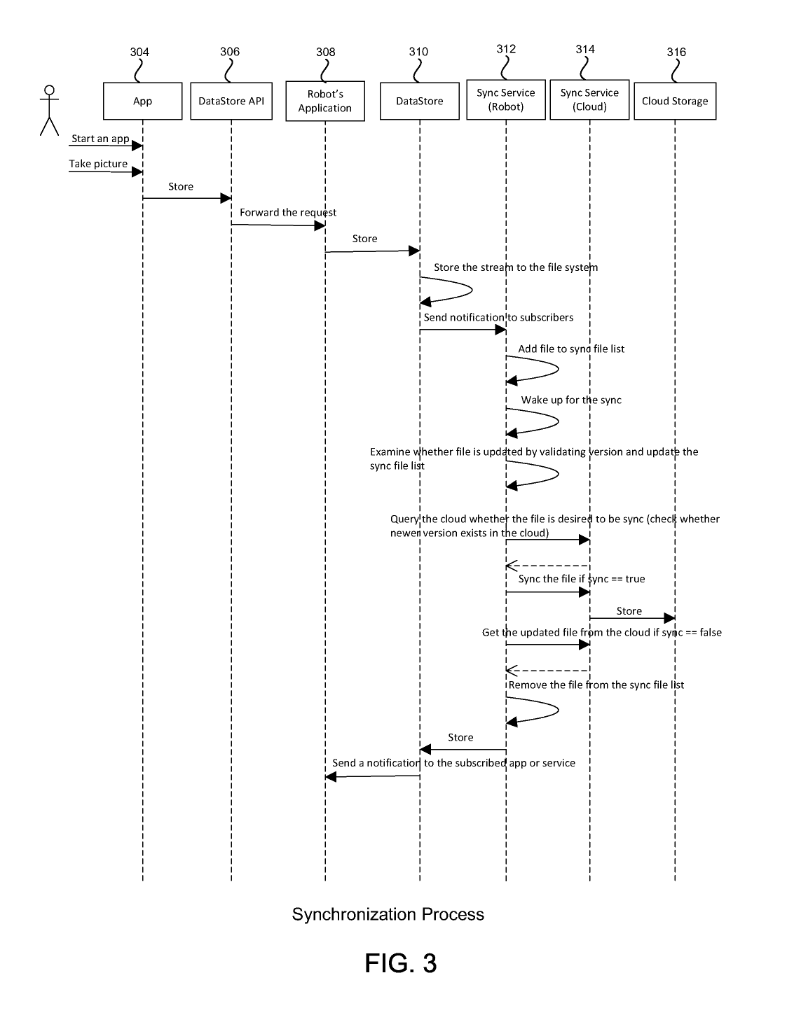

FIG. 3 illustrates a further example of synchronizing information captured via an application 304. The application may obtain a picture or photo that is sent to a datastore API 306 in the robotic device with a request to store the picture. This request can be forwarded to the robot's application 308 and the picture can be stored in a robotic device datastore 310. A notification can also be sent to subscribers for the local data stream and one of those can be synchronization service 312 for the robotic device. The robotic device can add the file to the synchronization list, and the service can wake up. The file can be examined and the version can be validated. A request can be made to the cloud as to whether the file can be synched. Then the file can be sent for synchronization to the cloud synchronization service 314. Then the file can be stored in the cloud storage service 316 and the appropriate cleanup can take place. If the file is not the most current version, then the current version of the file can be sent to the robotic device to be synchronized and stored on the robotic device.

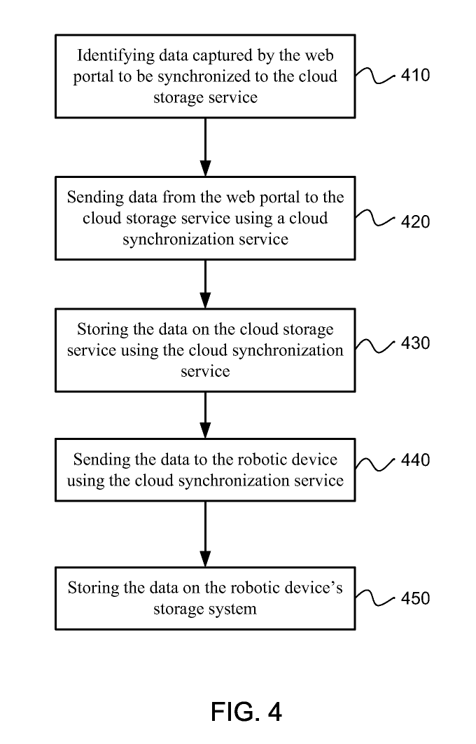

FIG. 4 illustrates a method for synchronization of data from a web portal to a cloud storage service and robotic device. The method can include identifying data captured by the web portal to be synchronized to the cloud storage service, as in block 410. The web portal can have a database to store configuration data, application data or any other data obtained by the web portal for the robotic device.

A further operation can be sending data from the web portal to the cloud storage service using a cloud synchronization service, as in block 420. The data from the web portal can then be stored on the cloud storage service using the cloud synchronization service, as in block 430.

The data can also be sent to the robotic device using the cloud synchronization service, as in block 440. The data can then be stored on the robotic device's storage system, as in block 450. This method can allow the configuration data of the robotic device to be changed at the robotic device directly or through the web portal. The state of robotic device can be synchronized in either direction so the configuration information or other data is accessible in a duplicate format at either the robotic device or the web portal. Files that are available on the robot can also be made available via the web portal or the cloud synchronization system after synchronization has taken place. In addition, the stored data may also be accessible through the web portal for remote configuration/access, and changes made via the web portal will subsequently synchronize back to the robotic device. Thus, a synchronization service is provided between a robot, and a cloud, and a web portal.

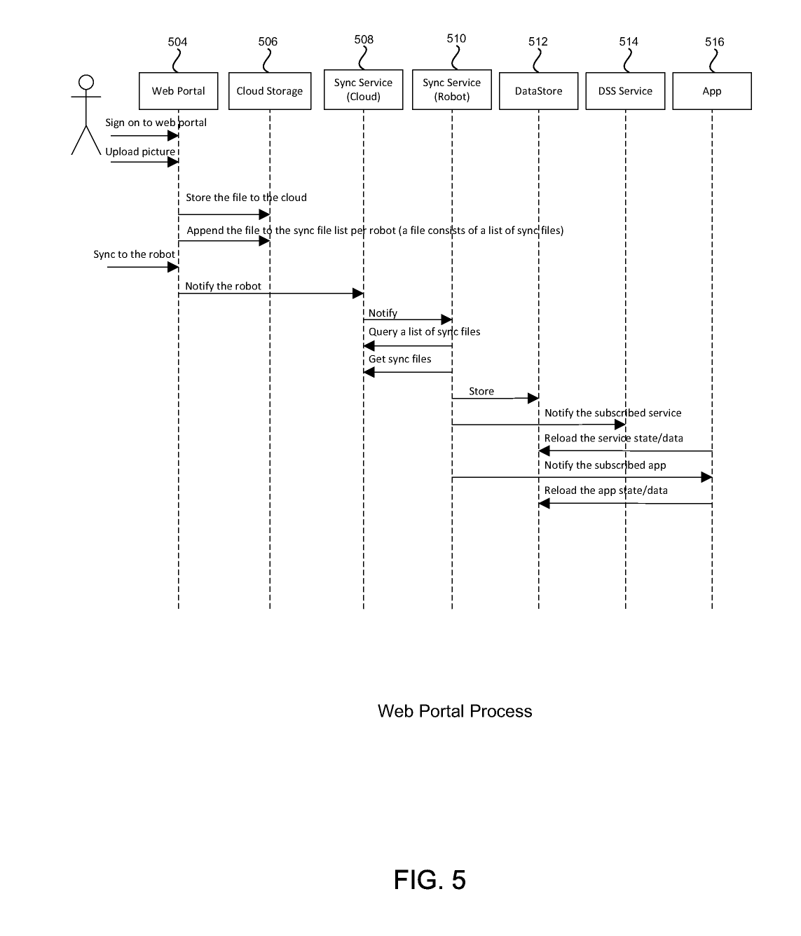

FIG. 5 illustrates an example process for synchronizing data from the web portal 504 to the robotic device using the cloud synchronization service. In one case, a picture or photo can be captured and the user can sign on to the web portal. Then the picture can be uploaded to the web portal. This file can then be stored to the cloud storage 506 when the request is made by the web portal to synchronize the picture to the cloud storage. The picture file can then be appended or added to the list of files to be synchronized to the robotic device. A file to be synchronized can also have a group of files to be synchronized.

The cloud synchronization service 508 can notify the robot synchronization service 510 that a synchronization operation is requested to be performed. The robot synchronization service can then query the cloud synchronization service for a list of files to be synchronized. This robot synchronization service can then retrieve the files to be synchronized and store the files in the robot data store 512. The data store can then notify the data store subscription (DSS) service 514 that a synchronization event has occurred. Then the application 516 can reload the services state and data that have been synchronized. The data store can then notify the subscribed application that data has changed for the application and the application state and application data can be reloaded. Other robot components can also subscribe to the data store subscription service to receive robot data store change notifications. When the robot data store detects any content change (e.g., application data or configurations), then the robot data store can send notifications to other robot components that are subscribed to the data store subscription service. The other robot components can then be updated too.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method for synchronization of data between a robotic device and a cloud storage service, comprising:
identifying data from a robotic device to be synchronized to the cloud storage service;
sending a synchronization request and the data to a robotic synchronization service on the robotic device;
storing the data on the robotic device's storage system;
sending the data to cloud synchronization service; and
storing the data on the cloud storage service.

2. The method as in claim 1, further comprising:
obtaining data relevant to the robotic device from a web interface;
sending the data from the web interface to the cloud synchronization service;
storing the data on the cloud storage service;
notifying the robotic device that a synchronization of data received from web interface is going to occur;
sending the data from the cloud synchronization service to the robotic device; and
storing the data from the cloud synchronization service on the robotic device's storage system.

3. The method as in claim 1, further comprising restoring data from the cloud storage service to the robotic device when the robotic device detects a data failure.

4. The method as in claim 1, further comprising synchronizing the data between the robotic device and the cloud storage service using at least one identifier selected from the group having of a robot identifier, a user identifier, and an application identifier.

5. The method as in claim 1, further comprising sending configuration data from a web portal to the robotic device via the cloud synchronization interface.

6. The method as in claim 1, further comprising sending instructions using a web portal to the cloud synchronization interface to rebuild data or applications on the robotic device using files from the cloud synchronization service.

7. The method as in claim 1, further comprising synchronizing data between the robotic device and the cloud synchronization service on a scheduled basis.

8. The method as in claim 1, further comprising synchronizing data between the robotic device and the cloud synchronization service in a forced mode where data is synchronized when network or robotic device utilization drops below a utilization threshold.

9. The method as in claim 1, further comprising further comprising synchronizing data between a web portal, the cloud synchronization service, and the robotic device after a change to data has been captured by the web portal.

10. The method as in claim 1, further comprising synchronizing data between the cloud synchronization service and the robotic device using a lazy synchronization that synchronizes a changed data portion after a change occurs.

11. The method as in claim 1, further comprising time stamping files to enable conflict resolution when synchronizing files for applications on the robotic device.

12. A system for synchronization of data for a robotic device, comprising:
a cloud storage service configured to store data;
a cloud synchronization interface to receive data to be stored in the cloud storage service;
a robotic device to store and process robotic configuration and application data, wherein the robotic device can synchronize the configuration and application data with the cloud storage service using the cloud synchronization interface; and
a web portal to capture web data for the robotic device and synchronize the data with the robotic device and cloud storage service via the cloud synchronization interface.

13. The system as in claim 12, further comprising a robot synchronization module to copy configuration and application data onto a robotic device's storage system.

14. The system as in claim 12, further comprising synchronizing the data between the robotic device and the cloud storage service using at least one identified selected from the group having of a robot identifier, a user identifier, and an application identifier.

15. The system as in claim 12, a restoration module to restore data from the cloud storage service to the robotic device when the robotic device detects a data failure.

16. The system as in claim 15, wherein robotic device data can be can be restored using the robot identifier, the user identifier, or the application identifier.

17. The system as in claim 14, a web portal database for storing configuration and application data for the robotic device in the web portal, wherein the web portal database is synchronized with the cloud storage service and robotic device.

18. A method for synchronization of data from a web portal to a cloud storage service and robotic device, comprising:
identifying data captured by the web portal to be synchronized to the cloud storage service;
sending the data to the cloud storage service using a cloud synchronization service;
storing the data on the cloud storage service using the cloud synchronization service;
sending the data to the robotic device using the cloud synchronization service; and
storing the data on the robotic device's storage system.

19. The method as in claim 19, further comprising a web portal with a database to store configuration data and application data.

20. The method as in claim 19, further comprising synchronizing the robotic device, the web portal and the cloud storage device using a scheduled synchronization, a forced synchronization, or a lazy synchronization.
